(19) United States
(12) Patent Application Publication
(10) Pub. No.: US 2025/0282549 A1
(43) Pub. Date: Sep. 11, 2025

(54) Storage System and Method for Temporary Storage

(71) Applicant: Kasparium ApS, Silkeborg (DK)

(72) Inventors: Tommy André BJØRBÆK, Hvam (NO); Morten BITSCH, Silkeborg (DK); Niels-Henrik Falk VEDEL, Ikast (DK)

(21) Appl. No.: 19/215,663

(22) Filed: May 22, 2025

Related U.S. Application Data
(63) Continuation of application No. PCT/DK2023/050285, filed on Nov. 27, 2023.

(30) Foreign Application Priority Data
Nov. 29, 2022 (DK) PA 2022 01082

(51) Int. Cl. B65G 1/04

(52) U.S. Cl. CPC B65G 1/0492

(57) ABSTRACT

A storage system comprising a bottom module extending parallel to a plane spanned by a first axis (X) and a second axis (Y) is disclosed. The bottom module comprises a plurality of bottom plates that are electrically connected to each other and form a planar support structure. Each bottom plate comprises several electrically driven driving wheels driven by one or more electrical motors. The driving wheels are arranged and configured for propelling an object placed on the bottom plate along the first axis (X) and the second axis (Y). Each bottom plate has a unique identification (ID), and one of the bottom plates is a master bottom plate that is configured to automatically identify and remember the ID of each bottom plate that is directly or indirectly electrically connected to the master bottom plate.

### CROSS-REFERENCE TO RELATED APPLICATIONS

This application is a continuation under 35 U.S.C. 111 of International Patent Application No. PCT/DK2023/050285, filed Nov. 27, 2023, which claims the benefit of and priority to Danish Application No. PA 2022 01082, filed Nov. 29, 2022, each of which is hereby incorporated by reference in its entirety.

### FIELD OF INVENTION

The present invention relates to a storage system for temporary storage of items. The present invention also relates to a method for temporary storage of items.

### BACKGROUND

The physical surroundings of a building typically determine the constraints of a storage system comprising a conveyer system. Accordingly, when a storage system has to be setup, the location-specific constraints have to be considered. More importantly, the prior art storage systems cannot be extended in an easy manner if a higher storage capacity is needed.

WO2022179933A1 discloses a puzzle-based storage system to be operated on a floor area, and a method for providing such, comprising a set of separate transportation assemblies placed together in a two-dimensional puzzle-based configuration occupying minimal floor area. Each transportation assembly comprises a rolling arrangement connected to a transportation body for moving the transportation assembly on the floor area, each transportation assembly is carrying and conveying a storage device. The rolling arrangement connected to each transportation body comprises at least four replaceable autonomous rolling devices, where each rolling device comprises a rolling element, driving means, sensors, controller, communication means, and a rechargeable power supply. This solution is, however, not suitable for moving a storage device relative to the transportation assembly carrying it.

Thus, there is a need for a storage system and a method which reduces or even eliminates the above-mentioned disadvantages of the prior art.

### BRIEF DESCRIPTION

It is an object of the disclosure to provide a storage system that can be extended in an easy manner if a higher storage capacity is needed. It is also an object of the disclosure to provide a storage system that can easily be setup in any location. It is an object of the disclosure to provide a storage system and a storage method that is suitable for moving a storage device relative to the transportation assembly carrying it.

A storage system according to an embodiment is a storage system comprising:
a bottom module extending parallel to a plane spanned by a first axis and a second axis, wherein the bottom module comprises a plurality of bottom plates that are communicatively connected to each other and form a planar support structure, wherein each bottom plate comprises several driving wheels driven by one or more driving structures,
a plurality of intermediate structures movably arranged on the bottom module, wherein the driving wheels are arranged and configured for propelling of the intermediate structures placed on the bottom plate along the first axis and along the second axis, wherein each bottom plate has a unique identification (ID) defined on the basis of the position of the bottom plate relative to the remaining bottom plates;
at least one pick station configured to receive the intermediate structures from the bottom module or from the remaining portion of the bottom module in case one or more bottom plates from the bottom module constitutes the at least one pick station;
an optimization module configured to contain information about the content of the intermediate structures, wherein the optimization module is configured to receive one or more requests about a requirement of the content of one or more of the intermediate structures, wherein the optimization module is configured to calculate a series of movements of intermediate structures that allows the one or more intermediate structures comprising the required content to be moved to the at least one pick station;
a control module that is communicatively connected to the optimization module and is configured to control the activity of the one or more driving structures on the basis of a control signal from the optimization module, wherein the driving wheels are arranged and configured for propelling an intermediate structure placed on the bottom plate.

Hereby, it is possible to move an intermediate structure relative to the bottom plate carrying it. Moreover, it is possible to move an intermediate structure that extends beyond a single bottom plate. Moreover, it is possible to save energy because only the bottom plates that are carrying the intermediate structure needs to be active. In the prior art, however, activation of a sequence of bottom plates is required because the wheels are located at the lower side of the bottom plates.

By the term “intermediate structure placed on the bottom plate” is meant that the intermediate structure is positioned on the top of the bottom plate.

The driving wheels are arranged in such a manner that they will bear against at least a portion of an intermediate structure positioned on the bottom plate. Hereby, the driving wheels can move the intermediate structure placed on the bottom plate. It is possible to move the intermediate structure even if the intermediate structure extends beyond the bottom plate. Accordingly, the system is suitable for moving an intermediate structure relative to the bottom plate.

In an embodiment, the bottom plate comprises:
a) at least two first driving wheels arranged and configured for propelling an intermediate structure placed on the bottom plate in a first direction; and
b) at least two second driving wheels arranged and configured for propelling the intermediate structure placed on the bottom plate in a second direction.

In an embodiment, the second direction extends perpendicular to the first direction.

In an embodiment, the uppermost portion of each wheel protrudes from the portion of the bottom plate that surrounds the wheel. Hereby, the wheel is configured and arranged for bearing against and hereby moving the intermediate structure placed on the bottom plate.

The driving wheels are arranged in such a manner that their upper portion will be in contact with an intermediate structure placed on the bottom plate.

In an embodiment, at least one of the bottom plates is a master bottom plate that is configured to automatically identify and remember the unique identification (ID) of each bottom plate that is directly or indirectly electrically connected to the master bottom plate.

Hereby, the entire storage system is self-configuring. The storage system can be disassembled and assembled in a new environment (in another building). Since the ID of each bottom plate is defined automatically by the master bottom plate, there is no need for identifying the ID of each bottom plate prior to disassembling the storage system. Moreover, the number of bottom plates in a system can be gradually increased without the need for setting up and calibrating the system. Moreover, it is possible to use a very small system (comprising a small number of bottom plates).

In an embodiment, the wheels are driven by one or more driving structures formed as one or more electrical motors. The driving structures can be mechanical structures driven by another energy source (e.g. a pneumatic or hydraulic energy source).

In an embodiment, the master bottom plate comprises the optimization module, which comprises a processing unit arranged and configured to process information and carry out an optimization based on a predefined optimization criterion. Hereby, it is possible to provide a compact and smart storage system.

In an embodiment, the optimization module of the master bottom plate is accessible and controllable wirelessly by an external device. Hereby, the users can apply an external device, such as a smartphone, as a user interface.

In an embodiment, the storage system is connected to a server via the internet (or via a wired or wireless connection), wherein the server comprises the optimization module, wherein the server is arranged and configured to process information and carry out an optimization based on a predefined optimization criterion, wherein the server is configured to receive information from the storage system and send information to the storage system.

In an embodiment, the storage system is connected to a server via the internet (or via a wired or wireless connection), wherein the server is communicatively connected to the optimization module, wherein the server is arranged and configured to process information and carry out an optimization based on a predefined optimization criterion, wherein the server is configured to receive information from the storage system and send information to the storage system.

In an embodiment, the storage system is connected to a standalone computer via a wired or wireless connection, wherein the computer is communicatively connected to the optimization module or comprises the optimization module, wherein the computer is arranged and configured to process information and carry out an optimization based on a predefined optimization criterion, wherein the computer is configured to receive information from the storage system and send information to the storage system.

In an embodiment, the bottom plate is rectangular and configured to automatically identify and remember the unique identification of each bottom plate that is directly or indirectly electrically connected to the master bottom plate by detecting if a bottom plate is connected to either of its sides.

In an embodiment, the bottom plate is square and configured to automatically identify and remember the unique identification of each bottom plate that is directly or indirectly electrically connected to the master bottom plate by detecting if a bottom plate is connected to either of its sides.

In an embodiment, the bottom plates are communicatively connected to each other by connections, wherein the bottom plates are also communicatively connected to each other by the same connections.

In an embodiment, the bottom plates are communicatively connected to each other by connections that apply light to communicate. In this embodiment, each connection comprises a light transmitter and a light receiver.

In an embodiment, the bottom plates are electrically connected to each other by connections, wherein the bottom plates are also communicatively connected to each other by the same connections.

In an embodiment, the storage system comprises a plurality of intermediate plates, wherein each intermediate plate is provided with two or more parallel first straight grooves and two or more parallel second straight grooves extending perpendicular to the first straight grooves, wherein the straight grooves are arranged and configured to engage with the driving wheels.

In an embodiment, each bottom plate comprises:
a) two or more first electrically driven driving wheels arranged and configured for propelling a shelving unit or an intermediate plate placed on the bottom plate along the first axis; and
b) two or more second electrically driven driving wheels arranged and configured for propelling a shelving unit or an intermediate plate placed on the bottom plate along the second axis.

In an embodiment, one or more of the bottom plates comprise two or more driving wheels arranged and configured for rotating an intermediate plate placed on the bottom plate along an axis extending perpendicular to the intermediate plate.

A method according to an embodiment is a method for temporarily storing items in a storage system that comprises:
a bottom module extending parallel to a plane spanned by a first axis and a second axis, wherein the bottom module comprises a plurality of bottom plates that are electrically connected to each other and form a planar support structure, wherein each bottom plate comprises several electrically driven driving wheels driven by one or more electrical motors,
a plurality of intermediate structures movably arranged on the bottom module, wherein the driving wheels are arranged and configured for propelling of the intermediate structures placed on the bottom plate along the first axis and along the second axis, wherein each bottom plate has a unique identification (ID) defined on the basis of the position of the bottom plate relative to the remaining bottom plates;
at least one pick station configured to receive the intermediate structures from the bottom module or from the remaining portion of the bottom module in case one or more bottom plates from the bottom module constitutes the at least one pick station;
an optimization module configured to contain information about the content of the intermediate structures, wherein the optimization module is configured to receive one or more requests about a requirement of the content of one or more of the intermediate structures, wherein the optimization module is configured to calculate a series of movements of intermediate structures that allows the one or more intermediate structures comprising the required content to be moved to the at least one pick station;
a control module that is communicatively connected to the optimization module and is configured to control the activity of the one or more electrical motors on the basis of a control signal from the optimization module,
   wherein the driving wheels are arranged and configured to propel an intermediate structure placed on the bottom plate.

In an embodiment, one of the bottom plates is a master bottom plate that is configured to automatically identify and remember the unique identification (ID) of each bottom plate that is directly or indirectly electrically connected to the master bottom plate.

Hereby, the method makes it possible to provide a self-configuring solution. The method allows the storage system to be disassembled, reassembled and placed in a new environment without the need for setting up and calibrating the system. Moreover, the number of bottom plates in a system can be gradually increased without the need for setting up and calibrating the system. Moreover, it is possible to use a very small system.

In an embodiment, the method comprises the step of applying a master bottom plate that comprises the optimization module, wherein the master bottom plate comprises a processing unit arranged and configured to process information and carry out an optimization based on a predefined optimization criterion.

In an embodiment, the method comprises the step of applying an external device to access and control the optimization module of the master bottom plate.

In an embodiment, the method comprises the step of connecting the storage system to a server via the internet, wherein the server is communicatively connected to the optimization module or comprises the optimization module, wherein the server is arranged and configured to process information and carry out an optimization based on a predefined optimization criterion, wherein the server is configured to receive information from the storage system and send information to the storage system.

In an embodiment, the method comprises the step of connecting the storage system to a standalone computer via a wired or wireless connection, wherein the computer is communicatively connected to the optimization module or comprises the optimization module, wherein the computer is arranged and configured to process information and carry out an optimization based on a predefined optimization criterion, wherein the computer is configured to receive information from the storage system and send information to the storage system.

In an embodiment, the bottom plate is rectangular and configured to automatically identify and remember the unique identification (ID) of each bottom plate that is directly or indirectly electrically connected to the master bottom plate by detecting if a bottom plate is connected to either of its sides.

In an embodiment, the storage system comprises a plurality of intermediate plates, wherein each intermediate plate is provided with two or more parallel first straight grooves and two or more parallel second straight grooves extending perpendicular to the first straight grooves, wherein the straight grooves are arranged and configured to engage with the driving wheels.

In an embodiment, each bottom plate comprises:
a) two or more first electrically driven driving wheels arranged and configured for propelling a shelving unit placed on the bottom plate along the first axis; and
b) two or more second electrically driven driving wheels arranged and configured for propelling a shelving unit placed on the bottom plate along the second axis.

### BRIEF DESCRIPTION OF THE DRAWINGS

The present systems and methods will become more fully understood from the detailed description given herein below. The accompanying drawings are given by way of illustration only, and thus, they are not limitative of the systems and methods. In the accompanying drawings:

FIG. 1A shows a schematic view of a portion of a storage system according to an embodiment;

FIG. 1B shows a close-up view of a portion of the storage system shown in FIG. 1B;

FIG. 2A shows a schematic view of a storage system according to an embodiment;

FIG. 2B shows a schematic view of another storage system according to an embodiment;

FIG. 3A shows a top view of a storage system according to an embodiment;

FIG. 3B shows a schematic view of a portion of a storage system according to an embodiment;

FIG. 4A shows a portion of a perspective view of a bottom plate, an intermediate plate and a shelving unit according to an embodiment;

FIG. 4B shows a schematic view of portions of a bottom plate that is configured to rotate an intermediate plate place on it;

FIG. 4C shows the bottom plate shown in FIG. 4B;

FIG. 5A shows a side view of a portion of a storage system according to an embodiment;

FIG. 5B shows a side view a of a portion of a storage system according to an embodiment;

FIG. 5C shows a side view a of a portion of a storage system according to an embodiment;

FIG. 6A shows a top view of a first storage system according to an embodiment;

FIG. 6B shows a top view of the first storage system shown in FIG. 6A being extended to a second system according to an embodiment;

FIG. 6C shows a top view of the second storage system shown in FIG. 6B being extended to a third system according to an embodiment;

FIG. 6D shows a top view of the third storage system shown in FIG. 6C being extended to a fourth system according to an embodiment;

FIG. 7A shows a schematic top view of a storage system according to an embodiment;

FIG. 7B shows a schematic top view of another storage system according to an embodiment;

FIG. 8A shows a schematic view of a master bottom plate of a storage system according to an embodiment;

FIG. 8B shows a schematic view of a master bottom plate of a storage system according to an embodiment;

FIG. 9A shows a schematic view of a bottom plate according of an embodiment;

FIG. 9B shows a schematic view of the bottom plate shown in FIG. 9A and an intermediate plate arranged above it;

FIG. 9C shows another view of the bottom plate and the intermediate plate shown in FIG. 9B;

FIG. 9D shows another view of the bottom plate and the intermediate plate shown in FIG. 9B and FIG. 9C; and

FIG. 9E shows a schematic view of two adjacent bottom plates and their communication units.

### DETAILED DESCRIPTION

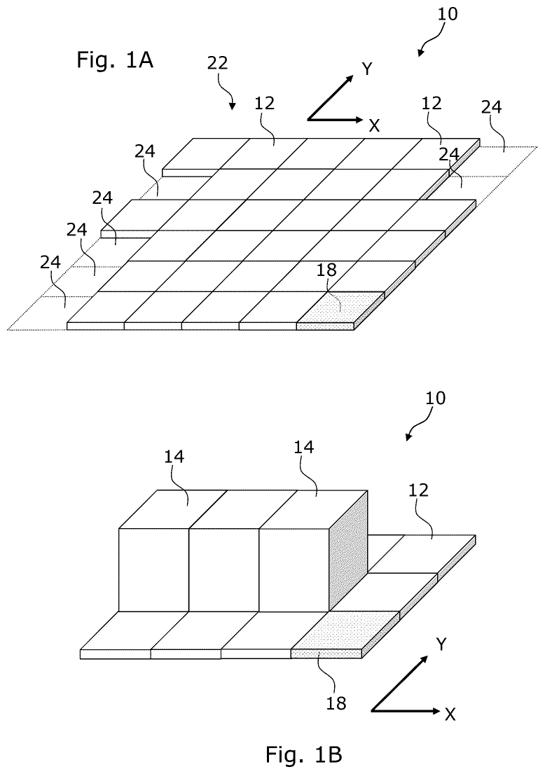

Referring now in detail to the drawings for the purpose of illustrating embodiments of the present systems and methods, a storage system 10 for temporary storage of items is illustrated in FIG. 1A. FIG. 1A illustrates a schematic view of a portion of a storage system according to the present disclosure. The storage system 10 is designed for temporary storage of items. The storage system 10 comprises a bottom module 22. The bottom module 22 extends parallel to a plane spanned by a first axis X and a second axis Y (extending perpendicular to the first axis X).

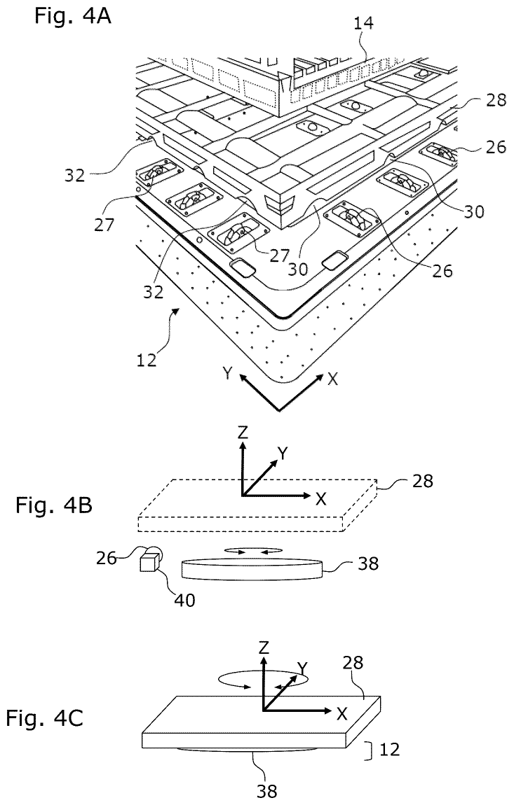

The bottom module 22 comprises a plurality of bottom plates 12 that are electrically connected to each other and form a planar support structure. Each bottom plate 12 comprises several electrically driven driving wheels (see FIG. 4A) that are driven by one or more electrical motors (see FIG. 4B).

The bottom module 22 comprises a plurality of intermediate structures (not shown in FIG. 1A) movably arranged on the bottom modules.

The driving wheels are arranged and configured for propelling the intermediate structures placed on the bottom plate(s) along the first axis X and along the second axis Y. Hereby, items (not shown) placed on the intermediate structures can be rearranged to pick-up or temporarily store one or more specific items.

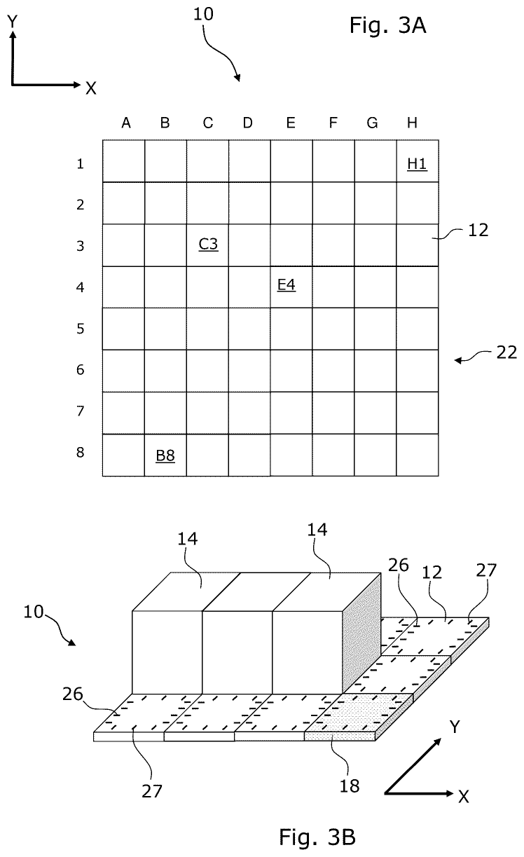

Each bottom plate 18 has a unique identification (ID) defined on the basis of the position of the bottom plate 18 relative to the remaining bottom plates 18. Accordingly, the position of bottom plate 18 will determine the ID of the bottom plate 18. In an embodiment, the rows will have numbers, and the columns will have letters (as shown in FIG. 3).

The storage system 10 comprises a pick station (not shown) configured to receive the intermediate structures from the bottom module 22 or from the remaining portion of the bottom module 22 in case one or more bottom plates 12 from the bottom module 22 constitute the pick station.

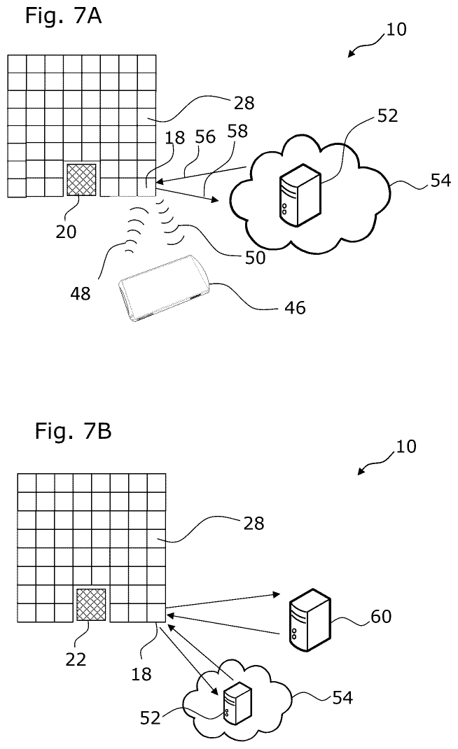

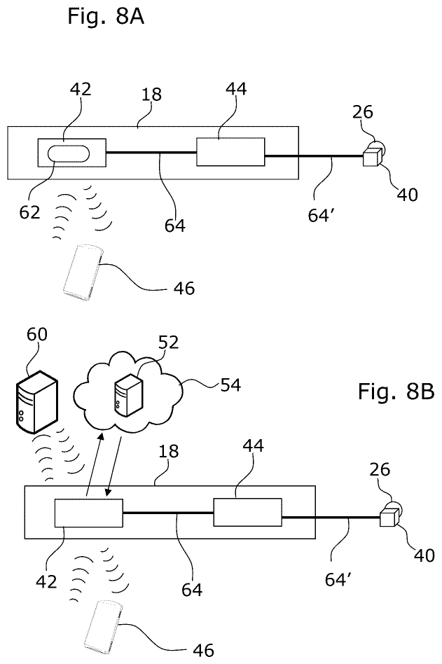

The storage system 10 comprises an optimization module (see FIG. 7A, FIG. 7B, FIG. 8A and FIG. 8B) configured to contain information about the content of the intermediate structures. The optimization module is configured to be updated every time one or more items are picked up from or stored in the storage system 10. This may be done by using a user interface (not shown) connected to the optimization module. In an embodiment, the user interface is a smartphone or a tablet. In an embodiment, the user interface is a computer.

The optimization module is configured to receive one or more requests about a requirement of the content of one or more of the intermediate structures. The optimization module is configured to calculate a series of movements of intermediate structures that allows the one or more intermediate structures comprising the required content to be moved to the pick station.

The storage system 10 comprises a control module (see FIG. 7A, FIG. 7B, FIG. 8A and FIG. 8B) that is communicatively connected to the optimization module and is configured to control the activity of the one or more electrical motors on the basis of a control signal from the optimization module.

The storage system 10 comprises one bottom plate 12 that is formed as a master bottom plate 18 that is configured to automatically identify and remember the unique ID of each bottom plate 12 that is directly or indirectly electrically connected to the master bottom plate 18.

The definition of the unique ID of each bottom plate 12 can be defined in the following way. Initially the master bottom plate 18 and the remaining bottom plates 12 are placed in the facility, in which the storage system 10 is required. Each bottom plate 12, 18 is electrically connected to their adjacent bottom plate 12, 18. Accordingly, all bottom plates 12, 18 are communicatively connected.

Hereafter the rectangular master bottom plate 18 identifies if there is a bottom plate 12 connected to all of the four sides of the master bottom plate 18. Moreover, the master bottom plate 18 identifies if there is a bottom plate 12 connected to the sides of each of the bottom plates 12 connected to the master bottom plate 18. This process is repeated until the position of all bottom plates 12 is identified.

As indicated, the bottom module 22 comprises a number of empty spaces 24. The empty spaces 24 do not contain any bottom plate 12.

The storage system 10 is extremely flexible compared to prior art storage systems because the storage system 10 can be packed up and unpacked and setup in another facility even if the shape and size of the other facility differs from the shape and size of the first facility. The storage system 10 is able to configure itself.

The bottom plates 12 of the storage system 10 can be placed in any desired configuration if the bottom plates 12 are connected. This means that a pillar in a facility would not be any problem, because the bottom plates 12 of the storage system 10 can be placed around the pillar.

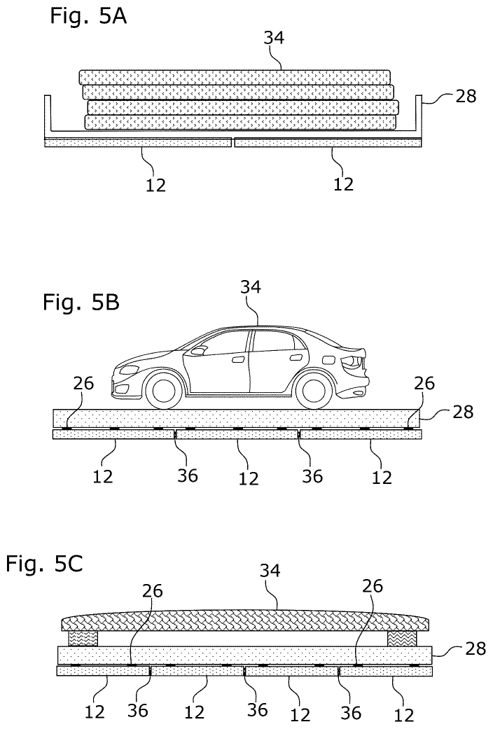

FIG. 1B illustrates a close-up view of a portion of the storage system 10 shown in FIG. 1A. The storage system 10 comprises a bottom module 22 that comprises a plurality of bottom plates 12 that are electrically and communicatively connected to a master bottom plate 18. The storage system 10 comprises a plurality of shelving units 14 that are moveably arranged on bottom plates 12. The shelving units 14 can contain various types of items. It is important to emphasize that the shelving units 14 can be replaced by other intermediate structures (see FIG. 4A, FIG. 5A, FIG. 5B, FIG. 5C).

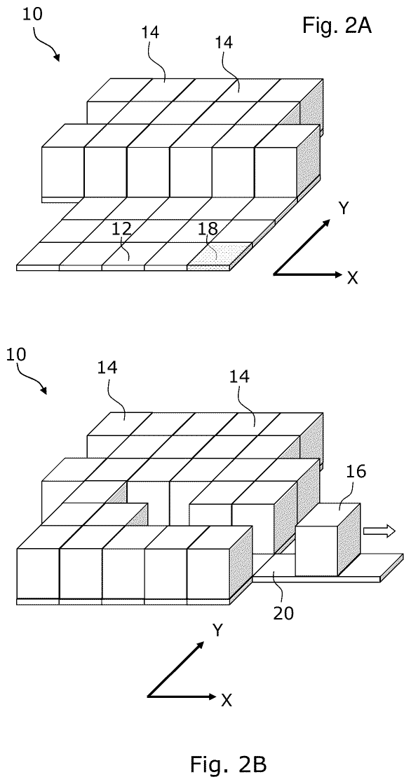

FIG. 2A illustrates a schematic view of a storage system 10 according to an embodiment. The storage system 10 comprises a bottom module 22 having a master bottom plate 18 and a plurality of bottom plates 12. The bottom plates 12 are electrically and communicatively connected to the master bottom plate 18. A plurality of shelving units 14 are moveably arranged on bottom plates 12. The shelving units 14 may be replaced by other intermediate structures (e.g. an intermediate plate).

FIG. 2B illustrates a schematic view of the storage system 10 shown in FIG. 2A in a configuration in which additional shelving units 14 are placed on the bottom plates 12. Accordingly, the storage capacity of the storage system 10 can be increased.

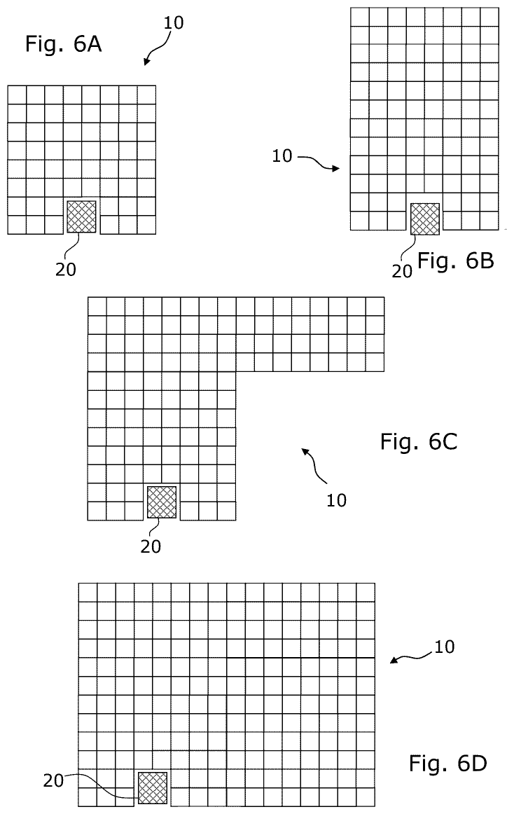

The storage system 10 comprises a pick station 20 onto which a picked shelving unit 16 is placed. It is important to emphasize that the pick station 20 typically would be arranged differently. The pick station 20 would typically be arranged in an indentation as shown in FIG. 6A, FIG. 6B, FIG. 6C and FIG. 6D.

FIG. 3A illustrates a top view of a storage system 10 according to an embodiment. The storage system 10 comprises a bottom module 22 that extends parallel to a plane spanned by a first axis X and a second axis Y (extending perpendicular to the first axis X). The bottom module 22 comprises 8 times 8 bottom plates 12. The 64 bottoms plates 12 have a unique ID defined by the position of each bottom plate 12. The ID is defined by the row number (1, 2, 3, 4, 5, 6, 7 or 8) and the column (A, B, C, D, E, F, G or H). In FIG. 3 the following bottom plates are indicated: H1, C3, E4 and B8. One of the bottom plates 12 is a master bottom plate (not indicated).

FIG. 3B illustrates a schematic view of a portion of a storage system 10 according to an embodiment. The storage system 10 basically corresponds to the one shown in and explained with reference to FIG. 1B.

The bottom module, however, comprises a plurality of bottom plates 12 each provided with several first driving wheels 26 and several second driving wheels 27.

The first driving wheels 26 are arranged and configured to move the shelving units 14 (or other intermediate structures placed on the bottom plates 12) in a first direction.

The second driving wheels 27 are arranged and configured to move the shelving units 14 (or other intermediate structures placed on the bottom plates 12) in another direction (extending perpendicular to the first direction).

Each bottom plate 12 is rectangular and comprises:
a) several first driving wheels 26 placed along two opposing edges of the bottom plate 12; and
b) several second driving wheels 27 placed along the two remaining and opposing edges of the bottom plate 12.

In an embodiment each bottom plate 12 is rectangular and comprises:
a) four first driving wheels 26 placed along two opposing edges of the bottom plate 12; and
b) three second driving wheels 27 placed along the two remaining and opposing edges of the bottom plate 12.

It is important to emphasize that the shelving units 14 can be replaced by other intermediate structures (see FIG. 4A, FIG. 5A, FIG. 5B, FIG. 5C).

FIG. 4A illustrates a perspective exploded view of a portion of a bottom plate 12, an intermediate plate 28 and a shelving unit 14 according to an embodiment. The bottom plate 12 comprises several first wheels 27 arranged and configured for propelling of the intermediate plate 28 along a first axis X.

The bottom plate 12 comprises several additional wheels 26 arranged and configured for propelling of the intermediate plate 28 along a second axis Y extending perpendicular to the first axis X.

The wheels 26, 27 are arranged to bear against the intermediate plate 28 carried by the bottom plate 12. Accordingly, the wheels 26, 27 are arranged to move the intermediate plate 28 (or another structure) that is placed on the bottom plate 12.

The intermediate plate 28 is provided with a plurality of straight grooves 32 arranged and configured to receive and guide the first wheels 27.

Likewise, the intermediate plate 28 is provided with a plurality of straight grooves 30 arranged and configured to receive and guide the additional wheels 26.

Each of the first wheels 27 and the additional wheels 26 are driven by one or more electrical motors. In an embodiment, the first wheels 27 are driven by one or more first electrical motors, wherein the additional wheels 26 are driven by one or more additional electrical motors. In an embodiment, the first wheels 27 are driven by a single first electrical motor while the additional wheels 26 are driven by a single additional electrical motor.

In an embodiment, the shelving unit 14 may be provided with grooves 30, 32 corresponding to the ones provided in the intermediate plate 28. When applying such embodiment, the intermediate plate 28 can be omitted.

FIG. 4B illustrates a schematic view of portions of a bottom plate that is configured to rotate an intermediate plate 28 placed on it.

The intermediate plate 28 is arranged and configured to be rotated about the vertical axis Z, while the intermediate plate 28 extends parallel to the plane spanned by the axes X, Y of the cartesian coordinate system indicated.

The bottom plate comprises an electrical turning unit 38 that is arranged and configured to rotate the intermediate plate 28 about the vertical axis Z. Moreover, the bottom plate comprises an electrical motor 40 arranged and configured to rotate a wheel 26 of the bottom plate and hereby propel the intermediate plate 28 along the X axis. The motor 40 may be arranged and configured to rotate several wheels of the bottom plate. In an embodiment, the bottom plate comprises an additional motor (not shown) configured to rotate another wheel (not shown) of the bottom plate and hereby propel the intermediate plate 28 along the Y axis.

FIG. 4C illustrates the bottom plate shown in FIG. 4B in a configuration in which the intermediate plate 28 is placed on the bottom plate 12.

FIG. 5A illustrates a side view of a portion of a storage system according to an embodiment. The storage system comprises an intermediate plate 28 that is supported by several (two or more) bottom plates 12. Hereby, it is possible to store large items 34 that cannot be stored in a small intermediate plate that covers a single bottom plate 12 only.

FIG. 5B illustrates a side view of a portion of a storage system according to an embodiment. The storage system comprises an intermediate plate 28 that is supported by a plurality (three times two) of bottom plates 12. Hereby, it is possible to temporarily store large items 34 like the car 34 that is indicated in FIG. 5B. Accordingly, the storage system can be used as a basement parking by way of example. One can see that the intermediate plates 28 comprise wheels 26 arranged to propel the intermediate plates 28. Adjacent bottom plates 12 are electrically and communicatively connected by a connection 36.

FIG. 5C illustrates a side view of a portion of a storage system according to an embodiment. The storage system comprises an intermediate plate 28 that is supported by four times two bottom plates 12. Accordingly, it is possible to temporarily store large items 34. The intermediate plates 28 comprise wheels 26 arranged to propel the intermediate plates 28. The adjacent bottom plates 12 are electrically and communicatively connected by a connection 36.

FIG. 6A illustrates a top view of a first storage system 10 according to an embodiment. The storage system 10 comprises a plurality of bottom plates and intermediate plates thereon. The storage system 10 comprises a pick station 20.

FIG. 6B illustrates a top view of the first storage system shown in FIG. 6A being extended to a second storage system 10 according to an embodiment. It can be seen that the storage system 10 has been extended by adding additional bottom plates and intermediate plates.

FIG. 6C illustrates a top view of the second storage system shown in FIG. 6B being extended to a third system 10 according to an embodiment. The storage system 10 has been extended by adding additional bottom plates and intermediate plates.

FIG. 6D illustrates a top view of the third storage system shown in FIG. 6C being extended to a fourth system 10 according to an embodiment. The storage system 10 has been extended by adding additional bottom plates and intermediate plates.

FIG. 6A, FIG. 6B, FIG. 6C and FIG. 6D illustrate that the storage system according to the present disclosure can be extended by adding additional bottom plates and intermediate plates. Accordingly, the storage system is flexible and offers the user an option to initially buy a small system and then gradually extend the system by adding bottom plates and intermediate plates. Moreover, the configuration of the system can easily be changed by rearranging the bottom plates and intermediate plates to shape a system of a different configuration (shape).

FIG. 7A illustrates a schematic top view of a storage system 10 according to an embodiment. The storage system 10 comprises a bottom module having a plurality of bottom plates, and intermediate plates 28 arranged on a plurality of the bottom plates. Some of the bottom plates are, however, empty to allow the intermediate plates to be moved to other bottom plates. The storage system 10 comprises a pick station 20 positioned in an indentation of the bottom plates.

The storage system 10 comprises a master bottom plate 18 that is arranged and configured to communicate with a smartphone 46. The master bottom plate 18 comprises an optimization module (not shown) and a control module (not shown) that is communicatively connected to the optimization module and is configured to control the activity of the one or more electrical motors (not shown) on the basis of one or more control signals from the optimization module.

The smartphone 46 can be used as a user interface allowing the user to send instructions to the optimization module of the storage system 10. The optimization module contains information about the content and position of the intermediate structures 28 and information about which bottom plates 28 are empty (contain no intermediate plate, shelving unit or item).

The optimization module is configured to receive one or more requests from the smartphone 46. The request may be a requirement of the content of one or more of the intermediate structures 28. The optimization module is configured to calculate a series of movements of intermediate structures 28 required to allow the one or more intermediate structures 28 comprising the required content to be moved to the pick station 20.

The control module is communicatively connected to the optimization module and is configured to control the activity of the one or more electrical motors that are arranged and configured for propelling of the intermediate plates 28 placed on the bottom plates along the axes of the plane along which the bottom module of the storage system is spanned.

The smartphone 46 can send signals 48 to and receive signals 50 from the optimization module.

In an embodiment, the optimization module of the storage system 10 is placed on a server 52 in a web-based service accessible via the internet 54. In this embodiment, signals 58 can be sent from the master bottom plate 18 to the server 52. Likewise, signals 56 can be sent from the server 52 to the master bottom plate 18. In this embodiment, the control unit of the master bottom plate 18 receives information/signals 56 via the Internet 54 from the optimization module located on the server 52.

FIG. 7B illustrates a schematic top view of another storage system 10 according to an embodiment. The storage system basically corresponds to the one shown in and explained with reference to FIG. 7A. The storage system 10, however, applies a computer 60 instead of a smartphone.

FIG. 8A illustrates a schematic view of a master bottom plate 18 of a storage system according to an embodiment. The master bottom plate 18 comprises an optimization module 42 and a control unit 44. The control unit 44 is communicatively connected to the optimization module 42 by a connection 64. This connection 64 may be a wired or wireless connection. The control unit 44 is connected to an electric motor 40 by a connection 64′ that may be wired or wireless. Accordingly, the control unit 44 can control the activity (speed and direction) of the motor 40. The motor 40 is arranged and configured to drive a wheel 26 of a bottom plate.

The optimization module 42 comprises a processing unit 62 arranged and configured to process information and thus provide the required optimization. The user of the storage system can access and control the optimization module 42 by a smartphone 46. The smartphone 46 can send signals to and receive signals from the optimization module 42.

FIG. 8B illustrates a schematic view of a master bottom plate 18 of a storage system according to an embodiment. The master bottom plate 18 basically corresponds to the one shown in and explained with reference to FIG. 8A. The master bottom plate 18, however, comprises a processing unit placed in a standalone computer 60 and/or in a server 52 accessible via the Internet 54.

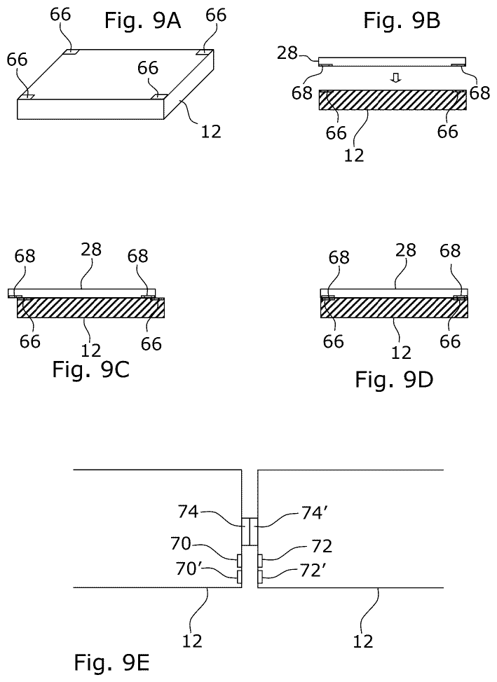

FIG. 9A illustrates a schematic view of a bottom plate 12 according of an embodiment. The bottom plate 12 comprises a number of magnets 66.

In an embodiment, the magnets 66 are permanent magnets 66 arranged in corner regions of the bottom plate 12.

By arranging permanent magnets 66 in predefined positions within the bottom plate 12, it is possible to use the position of the magnets 66 to place an intermediate plate (FIG. 9B, FIG. 9C and FIG. 9D) in a desired position relative to the bottom plate 12.

FIG. 9B illustrates a schematic view of the bottom plate 12 shown in FIG. 9A and an intermediate plate 28 arranged above the bottom plate 12. It can be seen that the intermediate plate 28 comprises sensors 68 arranged and configured to detect the presence and thus the position of the magnets 66 of the bottom plate 12. Hereby, the magnets 66 can be used to place the intermediate plate 28 in a predefined position relative to the bottom plate 12.

The magnets 66 and the sensors 68 are arranged in such a manner that the magnets 66 are placed right below the sensors 68 of the intermediate plate 28 when the intermediate plate 28 is aligned with and placed right over the bottom plate 12 like shown in FIG. 9D.

FIG. 9C illustrates another view of the bottom plate 12 and the intermediate plate 28 shown in FIG. 9B. In FIG. 9C, the magnets 66 are not placed right below the sensors 68 of the intermediate plate 28 because the intermediate plate 28 has not yet been aligned with and placed right over the bottom plate 12. In FIG. 9D, however, the magnets 66 are placed right below the sensors 68 of the intermediate plate 28 and the intermediate plate 28 is aligned with and placed right over the bottom plate 12.

In an embodiment, the magnets 66 are electromagnets powered by electric power available in the bottom plate 12 or an electrical connection in the proximity of the bottom plate 12.

In an embodiment, the magnets 66 of the bottom plate 12 are replaced by sensors 68, while the sensors 68 in the intermediate plate 28 are replaced by magnets 66.

FIG. 9E illustrates a schematic view of two adjacent bottom plates 12 and their communication units 70, 70′, 72, 72′. The left bottom plate 12 comprises a first communication unit 70 and a second communication unit 70′. The right bottom plate 12 comprises a first communication unit 72 and a second communication unit 72′.

In an embodiment, the communication units 70, 70′, 72, 72′ are arranged and configured to communicate using an ultraviolet communication technique.

In an embodiment, the communication units 70, 70′, 72, 72′ are arranged and configured to communicate using optical wireless communication (e.g. infrared light) that applies one or more light sources (such as light-emitting diodes).

In an embodiment, the bottom plates 12 are communicatively connected to each other by connections comprising light transmitters 70, 72 and light receivers 70′, 72′.

The bottom plates 12 are electrically connected to each other by electric connections 74, 74′. In an embodiment, adjacent bottom plates 12 are communicatively connected to each other by the electric connections 74, 74′.

List of reference numerals

| | |
|---|---|
| 1, 2, 3, 4 | Y coordinate |
| 5, 6, 7, 8 | Y coordinate |
| 10 | Storage system |
| 12 | Bottom plate |
| 14 | Shelving unit |
| 16 | Picked shelving unit |
| 18 | Master bottom plate |
| 20 | Pick station |
| 22 | Bottom module |
| 24 | Empty space |
| 26 | Driving wheel |
| 27 | Driving wheel |
| 28 | Intermediate plate |
| 30 | Groove |
| 32 | Groove |
| 34 | Item |
| 36 | Connection |
| 38 | Turning unit |
| 40 | Motor |
| 42 | Optimization module |
| 44 | Control unit |
| 46 | Smartphone |
| 48, 50 | Signal (information) |
| 52 | Server |
| 54 | Internet |
| 56, 58 | Signal |
| 60 | Computer (e.g. a server) |
| 62 | Processing unit |
| 64, 64′ | Connection |
| 66 | Magnet |
| 68 | Sensor |
| 70, 70′ | Communication unit |
| 72, 72′ | Communication unit |
| 74, 74′ | Electric connection |
| X, Y, Z | Axis |
| A, B, C, D | X coordinate |
| E, F, G, H | X coordinate |

What is claimed is:

1. A storage system comprising:
a bottom module extending parallel to a plane spanned by a first axis (X) and a second axis (Y), wherein the bottom module comprises a plurality of bottom plates that are communicatively connected to each other and form a planar support structure, wherein each bottom plate comprises several driving wheels driven by one or more driving structures,
a plurality of intermediate structures movably arranged on the bottom module, wherein the driving wheels are arranged and configured for propelling the intermediate structures placed on the bottom plates along the first axis (X) and along the second axis (Y), wherein each bottom plate has a unique identification (ID) defined based on a position of the bottom plate relative to remaining ones of the bottom plates;
at least one pick station configured to receive the intermediate structures from the bottom module or from a remaining portion of the bottom module in case one or more bottom plates from the bottom module constitute the at least one pick station;
an optimization module configured to contain information about content of the intermediate structures, wherein the optimization module is configured to receive one or more requests about a requirement of the content of one or more of the intermediate structures, wherein the optimization module is configured to calculate a series of movements of the intermediate structures that allows the one or more intermediate structures comprising the required content to be moved to the at least one pick station; and
a control module that is communicatively connected to the optimization module and is configured to control activity of the one or more driving structures based on a control signal from the optimization module.

2. The storage system according to claim 1, wherein one of the bottom plates is a master bottom plate that is configured to automatically identify and remember the unique identification (ID) of each bottom plate that is directly or indirectly electrically connected to the master bottom plate.

3. The storage system according to claim 2, wherein the master bottom plate comprises the optimization module, wherein the master bottom plate comprises a processing unit arranged and configured to process information and carry out an optimization based on a predefined optimization criterion.

4. The storage system according to claim 3, wherein the optimization module of the master bottom plate is accessible and controllable wirelessly by an external device.

5. The storage system according to claim 1, wherein the storage system is connected to a server via the internet, wherein the server is communicatively connected to the optimization module or comprises the optimization module, wherein the server is arranged and configured to process information and carry out an optimization based on a predefined optimization criterion, wherein the server is configured to receive information from the storage system and send information to the storage system.

6. The storage system according to claim 1, wherein the storage system is connected to a standalone computer via a wired or wireless connection, wherein the computer is communicatively connected to the optimization module or comprises the optimization module, wherein the computer is arranged and configured to process information and carry out an optimization based on a predefined optimization criterion, wherein the computer is configured to receive information from the storage system and send information to the storage system.

7. The storage system according to claim 2, wherein the bottom plate is rectangular and configured to automatically identify and remember the unique identification (ID) of each bottom plate that is directly or indirectly electrically connected to the master bottom plate by detecting if a bottom plate is connected to either of its sides.

8. The storage system according to claim 1, wherein all bottom plates are electrically connected to each other by connections, wherein the bottom plates are also communicatively connected to each other by the same connections.

9. The storage system according to claim 1, wherein the storage system comprises a plurality of intermediate plates, wherein each intermediate plate is provided with two or more parallel first straight grooves and two or more parallel second straight grooves extending perpendicular to the first straight grooves, wherein the first and second straight grooves are arranged and configured to engage with the driving wheels.

10. The storage system according to claim 9, wherein each bottom plate comprises:
a) two or more first electrically driven driving wheels arranged and configured for propelling a shelving unit or an intermediate plate placed on the bottom plate along the first axis (X); and
b) two or more second electrically driven driving wheels arranged and configured for propelling a shelving unit or an intermediate plate placed on the bottom plate along the second axis (Y).

11. A method for temporarily storing items in a storage system, the method comprising:
providing a storage system comprising:
a bottom module extending parallel to a plane spanned by a first axis (X) and a second axis (Y), wherein the bottom module comprises a plurality of bottom plates that are electrically connected to each other and form a planar support structure, wherein each bottom plate comprises several driving wheels driven by one or more driving structures,
a plurality of intermediate structures movably arranged on the bottom module, wherein the driving wheels are arranged and configured for propelling the intermediate structures placed on the bottom plates along the first axis (X) and along the second axis (Y), wherein each bottom plate has a unique identification (ID) defined based on a position of the bottom plate relative to remaining ones of the bottom plates;
at least one pick station configured to receive the intermediate structures from the bottom module or from a remaining portion of the bottom module in case one or more bottom plates from the bottom module constitute the at least one pick station;
an optimization module configured to contain information about content of the intermediate structures, wherein the optimization module is configured to receive one or more requests about a requirement of the content of one or more of the intermediate structures, wherein the optimization module is configured to calculate a series of movements of the intermediate structures that allows the one or more intermediate structures comprising the required content to be moved to the at least one pick station; and
a control module that is communicatively connected to the optimization module and is configured to control activity of the one or more driving structures based on a control signal from the optimization module; and placing at least one item in one of the plurality of intermediate structures.

12. The method according to claim 11, wherein one of the bottom plates is a master bottom plate that is configured to automatically identify and remember the unique identification (ID) of each bottom plate that is directly or indirectly electrically connected to the master bottom plate.

13. The method according to claim 12, wherein the method further comprises the step of applying a master bottom plate that comprises the optimization module, wherein the master bottom plate comprises a processing unit arranged and configured to process information and carry out an optimization based on a predefined optimization criterion.

14. The method according to claim 13, wherein the method further comprises the step of applying an external device to access and control the optimization module of the master bottom plate.

15. The method according to claim 11, wherein the method further comprises the step of connecting the storage system to a server via the internet, wherein the server is communicatively connected to the optimization module or comprises the optimization module, wherein the server is arranged and configured to process information and carry out an optimization based on a predefined optimization criterion, wherein the server is configured to receive information from the storage system and send information to the storage system.

16. The method according to claim 11, wherein the method further comprises the step of connecting the storage system to a standalone computer via a wired or wireless connection, wherein the computer is communicatively connected to the optimization module or comprises the optimization module, wherein the computer is arranged and configured to process information and carry out an optimization based on a predefined optimization criterion, wherein the computer is configured to receive information from the storage system and send information to the storage system.

17. The method according to claim 12, wherein the bottom plate is rectangular and configured to automatically identify and remember the unique identification (ID) of each bottom plate that is directly or indirectly electrically connected to the master bottom plate by detecting if a bottom plate is connected to either of its sides.

18. The method according to claim 11, wherein the storage system comprises a plurality of intermediate plates, wherein each intermediate plate is provided with two or more parallel first straight grooves and two or more parallel second straight grooves extending perpendicular to the first straight grooves, wherein the first and second straight grooves are arranged and configured to engage with the driving wheels.

19. The method according to claim 18, wherein each bottom plate comprises:
a) two or more first electrically driven driving wheels arranged and configured for propelling a shelving unit placed on the bottom plate along the first axis (X); and
b) two or more second electrically driven driving wheels arranged and configured for propelling a shelving unit placed on the bottom plate along the second axis (Y).
